(19) United States
(12) Patent Application Publication
(10) Pub. No.: US 2002/0080449 A1
(43) Pub. Date: Jun. 27, 2002

(54) Light transceiver apparatus

(76) Inventor: Chi Wang Tseng, Taipei Hsien (TW)

Correspondence Address: Rosenberg, Klein & Lee, 3458 Ellicott Center Drive-Suite 101, Ellicott City, MD, 21043, US

(21) Appl. No.: 09/741,188

(22) Filed: Dec. 21, 2000

(51) Int. Cl. H04B 10/00

(52) U.S. Cl. 359/152; 359/172

(57) ABSTRACT

A light transceiver apparatus comprises a receive module and an emitting module. The emitting module has a control unit with light emitting element. The light emitted from the light emitting element forms a wide-angle light and propagates to the receive module through one or multiple reflection. A plurality of light emitting elements is arranged uniformly and a lens is arranged atop the light emitting elements to provide a wide-angle light in omni-direction. The light from the light emitting element propagates, through direct or indirect transmission path, to the receive module.

### FIELD OF THE INVENTION

The present invention relates to a light transceiver apparatus, especially to a light transceiver apparatus with a light emitter, which emits light with broad angle spreading.

### BACKGROUND OF THE INVENTION

The conventional electronic devices or electronic circuits generally rely on physical wiring such as cable or twisted pair to convey electrical signal. However, the separation of signal transmission is restricted by the length of physical wiring, this is inconvenient and inflexible. Moreover, the wiring becomes overcrowded when many devices are wired within a small place. To over come above problems, wireless medium such as infrared (IR) or radio frequency (RF) are developed to provide more convenient access. The RF transmission has the problem of harm to human body and mutual interference due to its high penetrability. Therefore, the IR transmission is more promising improvement to replace physical wire.

FIG. 1 shows a schematic view of a conventional wireless transceiver, which comprises an emitting module 1a and a receiver module 2a. The emitting module 1a has a control unit 10a with a light emitting element 11a such as an infrared light emitting diode (IR LED). The emitting module la uses the light emitted from the light emitting element 11a as light source and the control unit 10a is used to control the on and off of the light from the light emitting element 11a. The light emitting element 11a generates a light propagating along a rectilinear path to and received by the receiver module 2a. The receiver module 2a converts the received light to corresponding electrical signal.

The above-mentioned wireless transceiver can be used in computer product such as wireless keyboard and mouse. As shown in FIG. 2, the wireless mouse 4a or wireless keyboard (not shown) has an emitting module 1a and a computer 5a has a receiver module 2a with a predetermined separation to the emitting module 1a such that the receiver module 2a is located in a receivable range. The receiver module 2a receives light signal from the emitting module 1a and converts the received light to corresponding electrical signal. Therefore, the wireless mouse 4a or wireless keyboard (not shown) can be used to access the computer 5a.

However, if an obstacle 3 is present between the emitting module 1a and the receiver module 2a, as shown in FIG. 3, the signal light is reflected to other direction different to the rectilinear path by the obstacle 3. The signal light cannot reach the receiver module 2a or reach the receiver module 2a with undetectable intensity.

In a practical situation, if an obstacle 3 is present between the emitting module la of a wireless mouse 4a (or wireless keyboard, not shown) and the receiver module 2a of a computer, the access to the computer by the wireless mouse 4a is interfered.

### SUMMARY OF THE INVENTION

It is an object of the invention to provide a light transceiver apparatus comprising a receive module and an emitting module. The emitting module has a control unit with light emitting element. The light emitted from the light emitting element forms a wide-angle light and propagates to the receive module through one or multiple reflection. Therefore, the light emitted from the light-emitting element is detoured from the obstacle or reflected from the obstacle, and reaches the receiver module.

It is another object of the invention to provide a light transceiver apparatus comprising an emitting module with a plurality of light emitting elements to form a wide-angle light in omni-direction. The light from the light emitting elements can reach the receive module through direct or indirect transmission. The receive module is not required to face the light emitting elements. It is another object of the invention to provide a light transceiver apparatus comprising a light-diffusing lens atop the light emitting elements to provide a wide angle light source. The number of the light-emitting elements 11 can be adjusted to achieve optimal transmission efficiency with no wastage of power and cost.

The various objects and advantages of the present invention will be more readily understood from the following detailed description when read in conjunction with the appended drawing, in which:

### BRIEF DESCRIPTION OF DRAWING

FIG. 1 shows a schematic view of a prior art wireless transceiver;

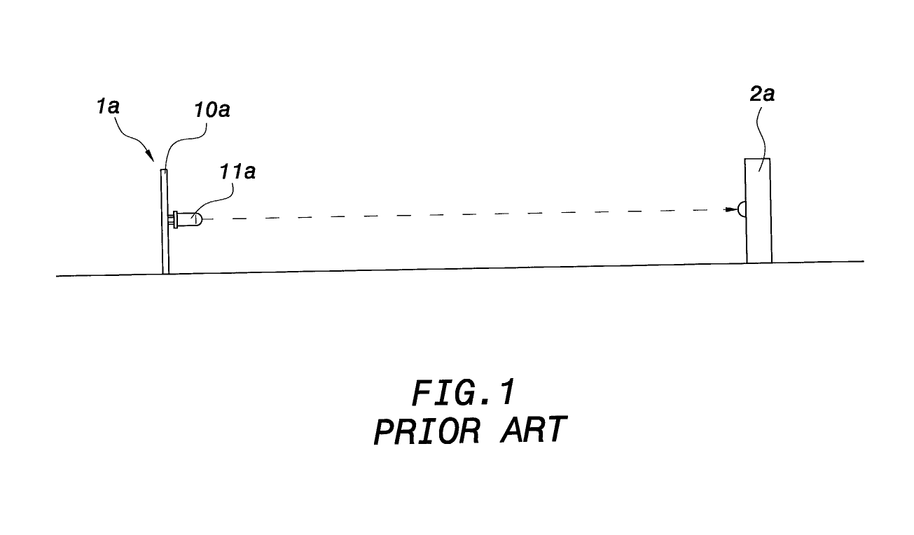

FIG. 2 shows that the prior art wireless transceiver is applied to a wireless mouse and compute;

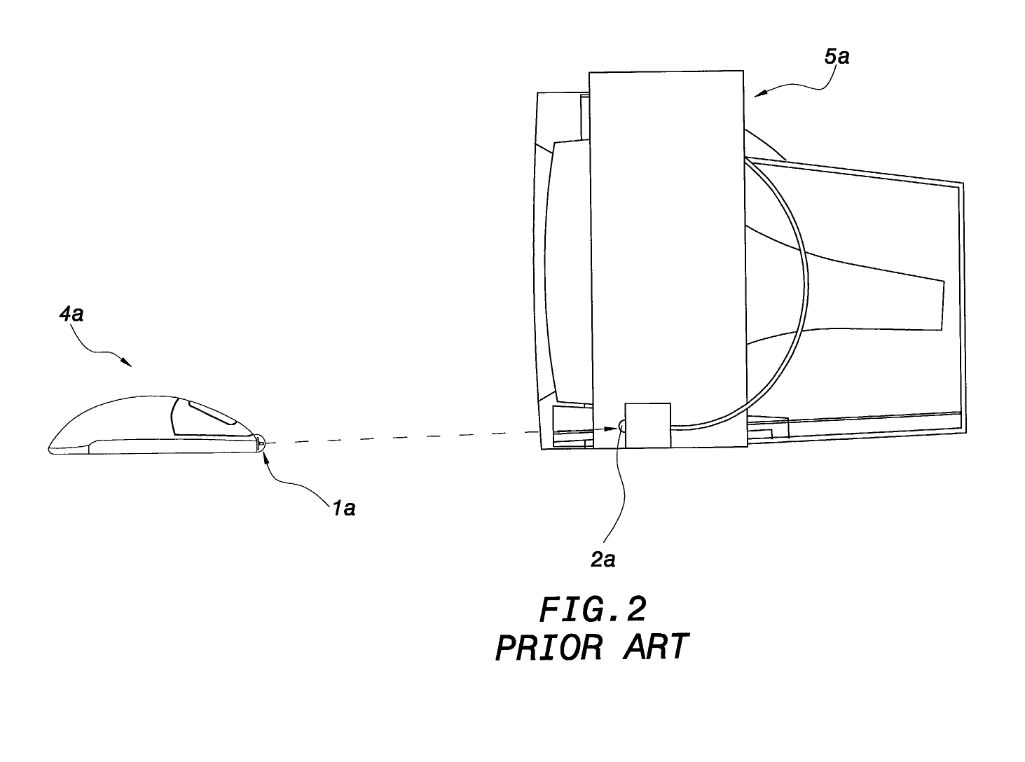

FIG. 3 shows the signal light of the prior art wireless transceiver is blocked by an obstacle;

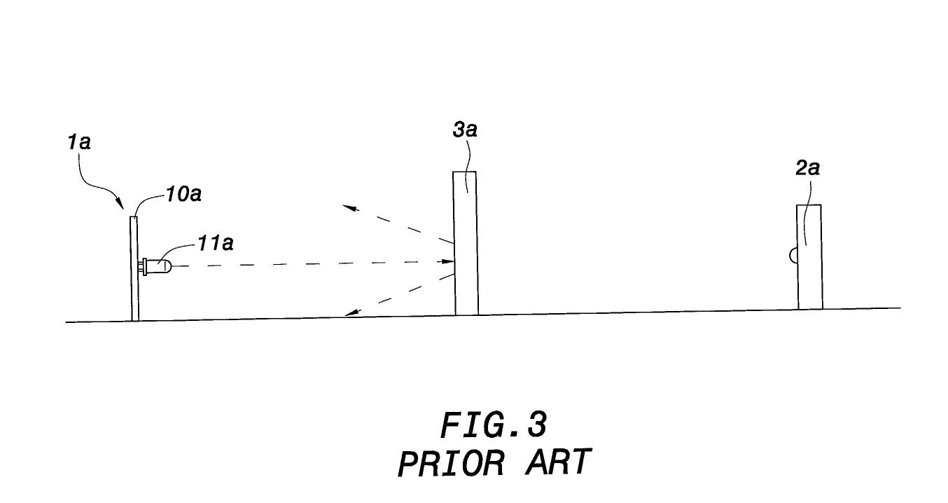

FIG. 4 shows the first feasible arrangements of light transceiver apparatus according to the present invention;

FIG. 5A shows the second feasible arrangements of light transceiver apparatus according to the present invention;

FIG. 5B shows the third feasible arrangements of light transceiver apparatus according to the present invention;

FIG. 6 shows that the signal light is emitted in a semi-circular direction;

FIG. 7 shows that the signal light is emitted in a semi-sphere direction;

FIG. 8 shows a light transceiver apparatus with a lens; and

FIG. 9 shows another preferred embodiment of the present invention.

### DETAILED DESCRIPTION OF THE INVENTION

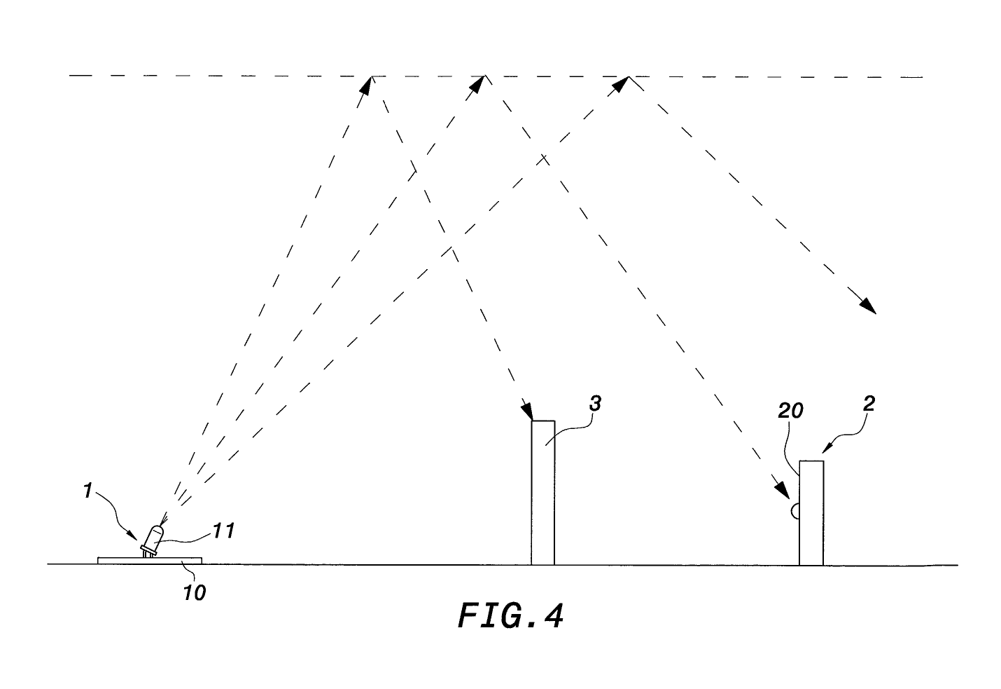

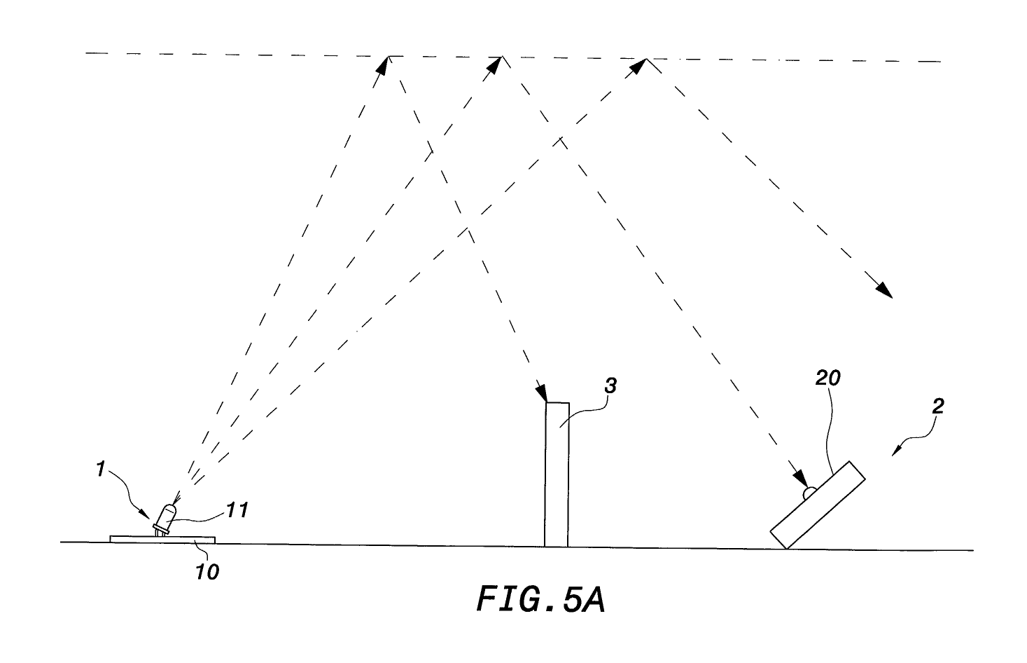

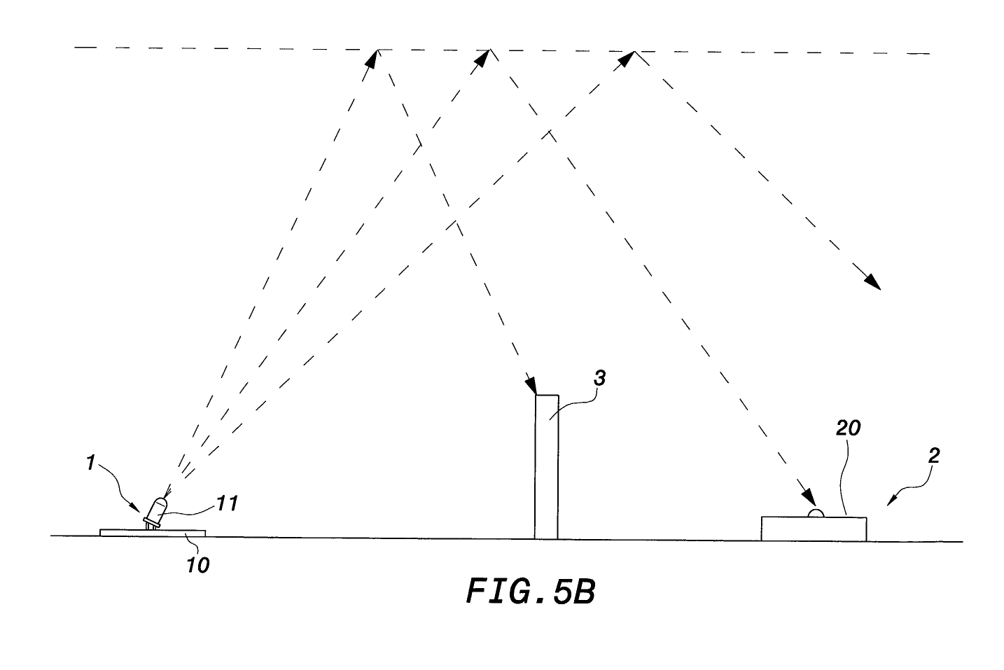

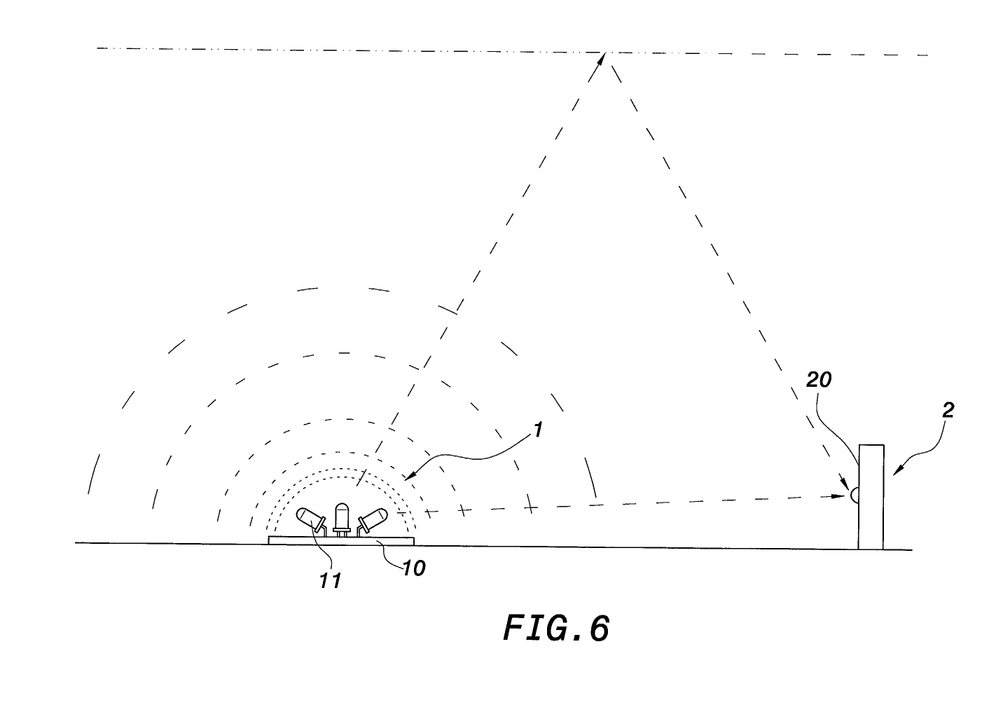

FIGS. 4 and 5A show the first and the second feasible arrangements of light transceiver apparatus according to the present invention. The present invention provides a light transceiver apparatus comprising an emitting module 1 and a receiver module 2. The emitting module 1 has a control unit 10 with a light emitting element 11 such as an infrared light emitting diode (IR LED). The emitting module 1 has an inclined angle or vertical to the horizon such that the signal light emitted from the emitting module 1 is reflected by wall, ceiling or ground in the room. After multiple reflections, the signal light emitted from the emitting module 1 can detour the obstacle 3 and form a broad-angled light toward the receiver module 2. Moreover, the signal light emitted from the emitting module 1 can also reflected by the obstacle 3 and then propagates to the receiver module 2. Alternatively, the receiving plane 20 of the receiver module 2 is also tilted with a predetermined angle or faced upward as shown in FIG. 5B such that the receiver module 2 can receive signal light from upper direction. Therefore, the signal accepting probability is increased. The light-emitting angle of the light-emitting element 11 is spreading about 30 degree with respect to the axis of the light-emitting element 11. Therefore, the signal light is a conical light with spreading angle about 60 degree. As shown in FIG. 6, in a plane vertical to the horizon, three light-emitting elements 11 are provided, wherein a center light-emitting element 11 is vertical to the horizon and two other light-emitting elements 11 are arranged on each side of the center light-emitting element 11 with 60 degree separation angle to the center light-emitting element 11. Therefore, light emitting from the three light-emitting elements 11 cover a semi-circular angle in this plane. The light emitted from the light-emitting elements 11 may be propagated directly toward the receiver module 2, or alternatively, in directly propagated to the receiver module 2 through one or multiple reflection.

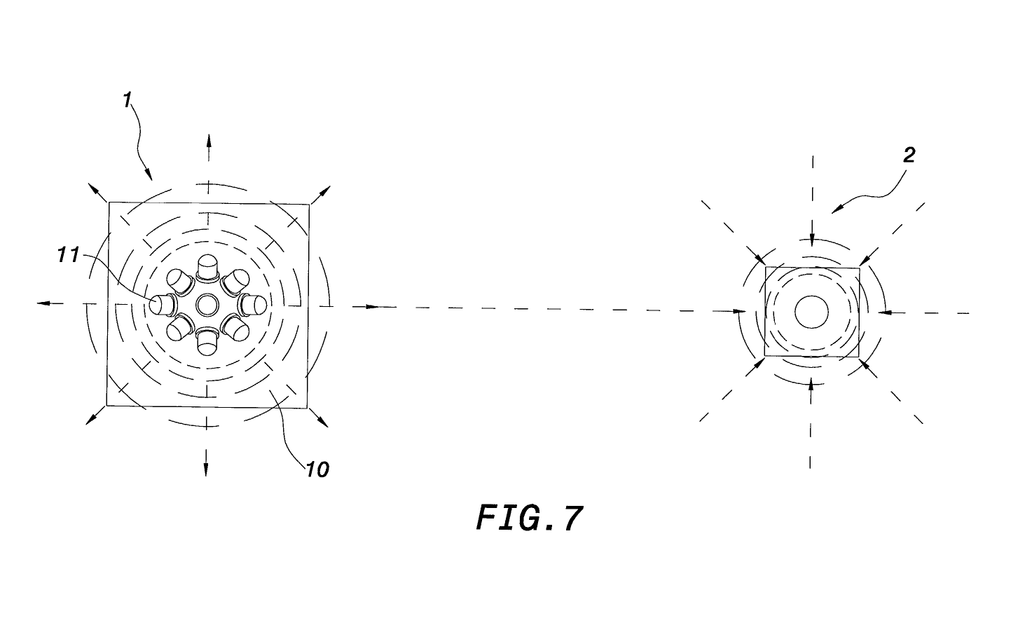

With reference to FIG. 7, to provide a wide-angle light transceiver apparatus in omni-direction, a plurality of light-emitting elements 11 are equally provided on the control unit 10 such that the signal light from the light-emitting elements 11 form three-dimensional semi-sphere pattern. No matter what angle the receiver module 2 is with respect to the light-emitting elements 11, the receiver module 2 can detect the light emitted from the light-emitting elements 11 as long as the position of the receiver module 2 does not induce an unacceptable power drop. Therefore, this configuration provides a wide-angle light transceiver apparatus with no dead angle.

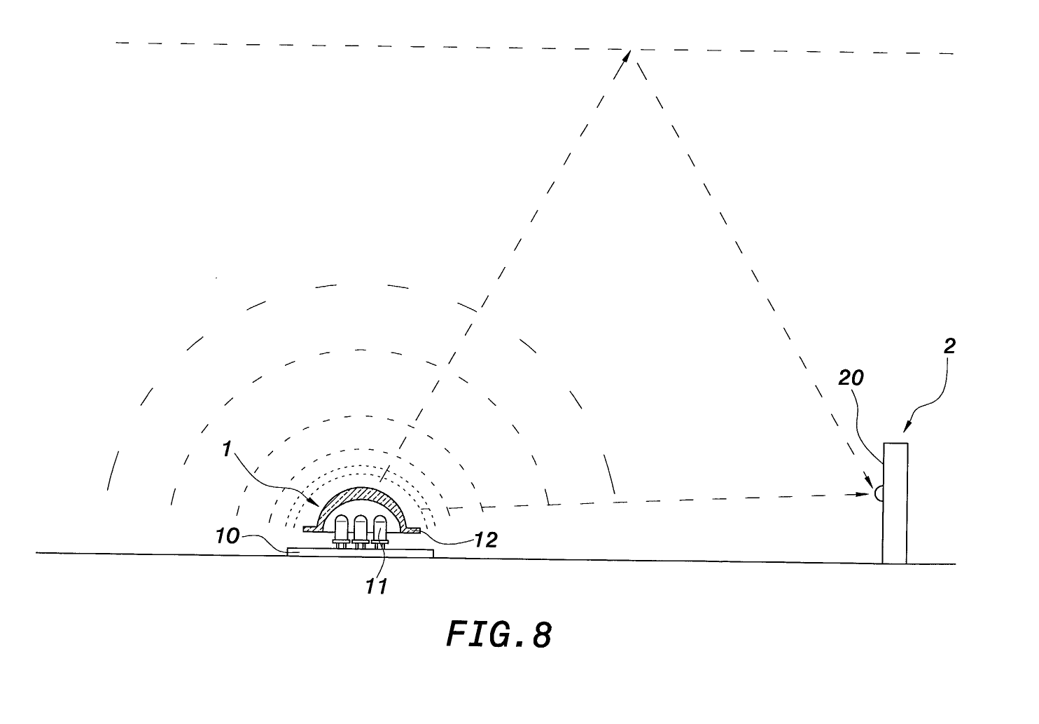

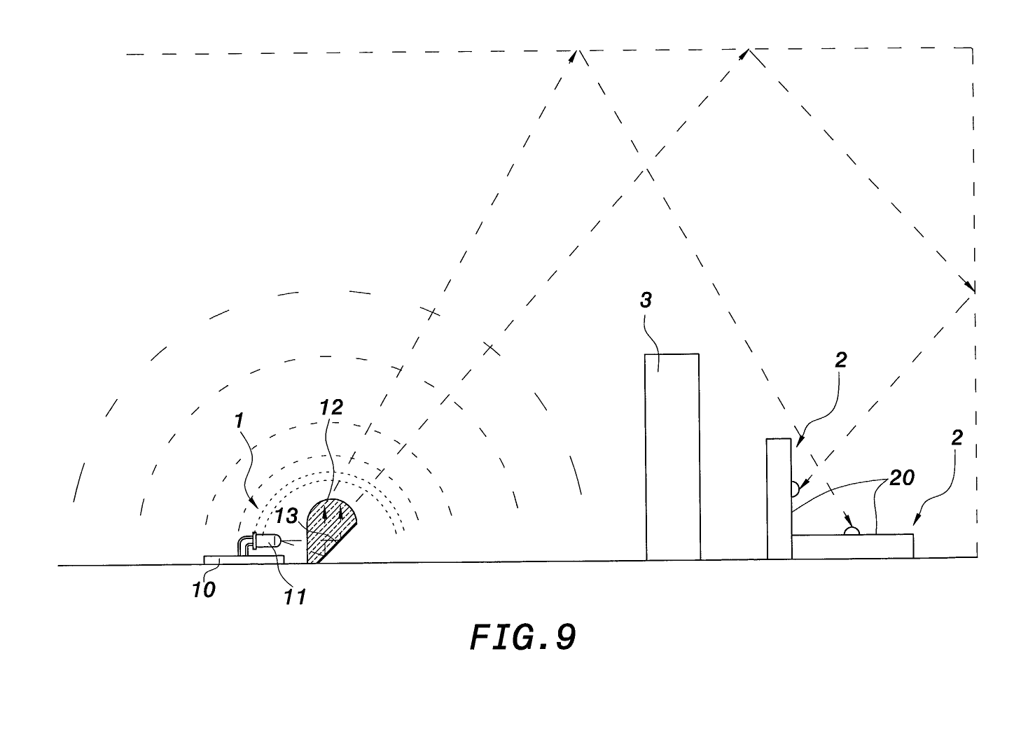

Moreover, as shown in FIG. 8, a light-diffusing lens 12 is provided over the light-emitting element 11. The light emitted from the light-emitting element 11 is diffused by the light-diffusing lens 12 to form a light with larger angle spreading. The number of the light-emitting element 11 can be adjusted to with reference to the transmitting power budget and distance. Moreover, as shown in FIG. 9, the inventive light transceiver apparatus can also adopt two sets of receiver modules 2 in serial or parallel connection. The receiving spaces of the receiver modules 2 are oriented vertically or slantingly. Therefore, the detection of light from the light-emitting element 11 is easier. Moreover, the light emitted from the light-emitting element 11 can be reflected by a reflecting surface 13 and pass through a light-diffusing lens 12. The light emitted from the light-emitting element 11 is diffused by the light-diffusing lens 12.

The inventive light transceiver apparatus can be adapted for application of wireless mouse or wireless keyboard and has following advantages:

First, the light-emitting element 11 is either in inclined or vertical arrangement and the signal light forms a wide-angle light after one or multiple reflection and propagates to the receiver modules 2. Therefore, the light emitted from the light-emitting element 11 is detoured from the obstacle 3 and reaches the receiver module 2.

Secondly, a plurality of light-emitting elements 11 are arranged uniformly to form a wide-angle light in omni-direction, the light emitted from the light-emitting elements 11 can be received by the receiver module 2 as long as the receiver module 2 is located within an accepted range, irrespective to the direction thereof. The plurality of light-emitting elements 11 arranged uniformly can provide light source with no dead angle.

Thirdly, a light-diffusing lens 12 is employed to provide a wide angle light source, and the number of the light-emitting elements 11 can be adjusted to achieve optimal transmission efficiency with no wastage of power and cost.

To sum up, the present invention provides an improved light transceiver apparatus to overcome the problem of the conventional light transceiver apparatus, wherein the light emitted from the conventional light transceiver apparatus propagates in a rectilinear direction and is liable to be blocked by obstacles.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A light transceiver apparatus comprising
a receive module; and
an emitting module having a control unit with at least one light emitting element; the light emitting element being in inclined or vertical arrangement, the light emitted from the light emitting element forming a wide-angle light and propagating to the receive module through direct or indirect transmission path and through one or multiple reflection.

2. The light transceiver apparatus as in claim 1, wherein the receive module has a light receiving plane facing upward or slantingly.

3. The light transceiver apparatus as in claim 2, wherein the receive module is composed of at least two light receiving planes in series or parallel connection.

4. The light transceiver apparatus as in claim 1, wherein the emitting module further comprises a lens to diffuse the light from the light emitting element and located atop the light emitting element.

5. The light transceiver apparatus as in claim 1, wherein the emitting element is an infrared light emitting diode.

6. The light transceiver apparatus as in claim 1, wherein the emitting element is arranged uniformly on the control unit.
